(19) United States
(12) Patent Application Publication
(10) Pub. No.: US 2014/0044925 A1
(43) Pub. Date: Feb. 13, 2014

(54) PROTECTIVE COVER MADE WITH SAPPHIRE AND METHOD OF MANUFACTURING SAME

(71) Applicant: HON HAI PRECISION INDUSTRY CO., LTD., New Taipei (TW)

(72) Inventor: SHAO-KAI PEI, New Taipei (TW)

(73) Assignee: HON HAI PRECISION INDUSTRY CO., LTD., New Taipei (TW)

(21) Appl. No.: 13/726,651

(22) Filed: Dec. 26, 2012

(30) Foreign Application Priority Data
Aug. 9, 2012 (TW) 101128762

(51) Int. Cl. B05D 3/06

(52) U.S. Cl. CPC B05D 3/06
USPC 428/164; 428/161; 427/555

(57) ABSTRACT

A protective cover includes a substrate, a pattern layer, and an oil resistance layer. The substrate is made of sapphire and includes an upper surface and a lower surface. The pattern layer covers on some portions of the upper surface. The oil resistance layer is coated on a side of the pattern layer opposite to the substrate and the other portions of the upper surface without being covered with the pattern layer.

### BACKGROUND

1. Technical Field

The present disclosure relates to protective covers, and particularly, to a protective cover made with sapphire and a method of manufacturing the protective cover.

2. Description of Related Art

Protective covers are widespread, being used in lenses, cars, computers in just about all industry. The protective covers are generally made of plastic or glass, of which the hardness, strength, and weather resistance are often less than satisfactory. As such, this kind of the protective cover cannot be used in harsh environment conditions.

Therefore, it is desirable to provide a protective cover and a method of manufacturing the protective cover, which can overcome the limitations described.

### BRIEF DESCRIPTION OF THE DRAWINGS

FIG. 1 is a cross-sectional schematic view of a protective cover in accordance with an exemplary embodiment.

FIG. 2 is a flow chart of a method of manufacturing the protective cover of FIG. 1 in accordance with another exemplary embodiment.

### DETAILED DESCRIPTION

Embodiments of the disclosure will be described with reference to the drawings.

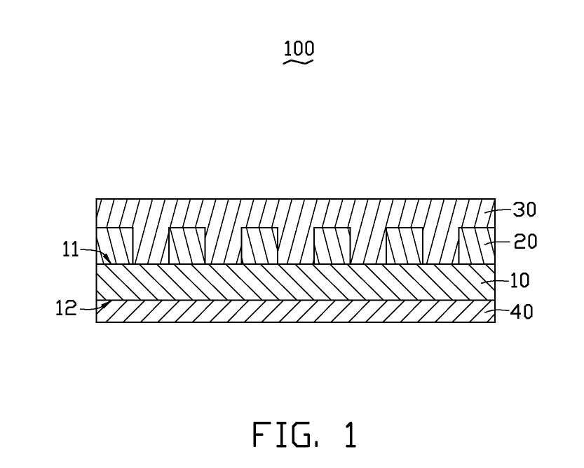

FIG. 1 shows a protective cover 100 according to an exemplary embodiment. The protective cover 100 is used in a lens, a car, or a computer. The protective cover 100 includes a substrate 10, a pattern layer 20, an oil resistance layer 30, and an anti-ultraviolet film 40. In the embodiment, the protective cover 100 is used to cover on an objected side of the lens (not shown).

The substrate 10 is plate shaped, and is made of sapphire. The sapphire is a gemstone variety of the mineral corundum, and has a hexagonal crystal structure. The main chemical component of sapphire is aluminum oxide, and the refractive index of the sapphire is from about 1.757 to about 1.760. The growth direction of the sapphire is a-axis (11 2̅0), c-axis (0001), m-axis (10 1̅0). The hardness, the strength, and the weather resistance of the sapphire are greater than that of the common glass or the plastic. The substrate 10 includes an upper surface 11 and a lower surface 12 opposite to the upper surface 11.

In the embodiment, the hardness of the sapphire is from about 1500 Kg/mm² to about 2000 Kg/mm², the yield strength of the sapphire is from about 300 MPa to about 400 MPa, the compressive strength of the sapphire is about 2 GPa, the temperature range of the sapphire is from about −40° C. to about 2000° C.

The pattern layer 20 covers on the upper surface 11 of the substrate 10, and is configured for shielding a part of light rays protected thereon. Users cannot see an internal structure of the lens through the protective cover 10. The pattern layer 20 is made from a ceramic powder. In process of forming the pattern layer 20, a layer of ceramic powder is uniformity spread on the upper surface 11, and then a part of the layer of ceramic powder is sintered on the upper surface 11 by a laser light according to a preset pattern, the other part of the layer of the ceramic powder without being sintered is removed from the upper surface 11. The ceramic powder sintered on the upper surface 11 forms the pattern layer 20.

In the embodiment, the sintering temperature of the ceramic powder is from about 1500° C. to about 1800° C. The major composition of the ceramic powder is aluminum phosphate and silicon dioxide.

The oil resistance layer 30 is coated on a side of the pattern layer 20 opposite to the substrate 10 and portions of the upper surface 11 of the substrate 10 without being covered with the pattern layer 20. The major composition of the oil resistance layer 30 is metal nanometer film. In process of forming the oil resistance layer 30, a layer of metal film is uniformity coated on the pattern layer 20 and the substrate 10 by the coating technology. Then the structure of the metal film is changed to a micro nanostructure by the method of the rapid thermal process, the surface of the micro nanostructure is chemically modified by an organics containing fluorine.

The anti-ultraviolet film 40 is coated on the lower surface 12 of the substrate 10 opposite to the pattern layer 20. The anti-ultraviolet film 40 is configured for filtering ultraviolet light.

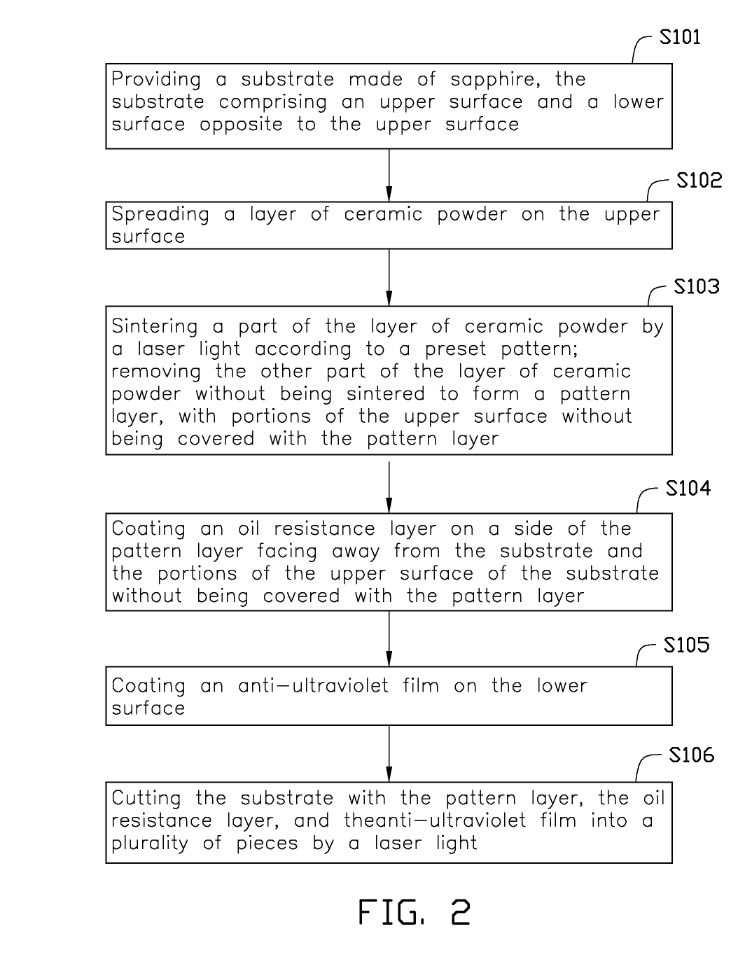

FIG. 2 shows a manufacturing method, according to an exemplary embodiment. The manufacturing method is used to manufacture the protective cover 100. The manufacturing method includes steps of S101-S106.

S101: a substrate 10 made of sapphire is provided. The hardness, the strength, and the weather resistance of the sapphire are greater than that of the common glass or the plastic. The substrate 10 includes an upper surface 11 and a lower surface 12 opposite to the upper surface 11.

S102: a layer of ceramic powder is spread on the upper surface 11 of the substrate 10. The major composition of the ceramic powder is aluminum phosphate and silicon dioxide.

S103: a part of the ceramic powder is sintered on the substrate 10 by a laser light according to a preset pattern and the ceramic powder that has not been sintered on the substrate 10 is removed. The ceramic powder sintered on the substrate 10 forms a pattern layer 20. In the embodiment, the sintering temperature of the ceramic powder is from about 1500° C. to about 1800° C.

S104: an oil resistance layer 30 is coated on a side of the pattern layer 20 opposite to the substrate 10 and portions of the upper surface 11 of the substrate 10 without being covered with the pattern layer 20. In the process of forming the oil resistance layer 30, a layer of metal film is uniformity coated on the pattern layer 20 and the portions of the upper surface 11 of the substrate 10 without being covered with the pattern layer 20 by coating technology. Then the structure of the metal film is changed to a micro nanostructure by the rapid thermal process, a surface of the micro nanostructure is chemically modified by an organics containing fluorine.

S105: an anti-ultraviolet film 40 is coated on the lower surface 12 of the substrate 10 opposite to the pattern layer 20.

S106: the substrate 10 with the pattern layer 20, the oil resistance layer 30, and the anti-ultraviolet film 40 is cut into a number of pieces with less size by laser light.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A protective cover, comprising:
a substrate made of sapphire, and comprising an upper surface and a lower surface opposite to the upper surface;
a pattern layer covering on some portions of the upper surface; and
an oil resistance layer coated on a side of the pattern layer facing away from the substrate and the other portions of the upper surface without being covered with the pattern layer.

2. The protective cover of claim 1, wherein the pattern layer is made from the ceramic powder, and the major composition of the ceramic powder is aluminum phosphate and silicon dioxide.

3. The protective cover of claim 1, wherein the major composition of the oil resistance layer is metal nanometer film.

4. The protective cover of claim 1, further comprising an anti-ultraviolet film coated on the lower surface.

5. A method of manufacturing a protective cover, comprising:
providing a substrate made of sapphire, the substrate comprising an upper surface and a lower surface opposite to the upper surface;
spreading a layer of ceramic powder on the upper surface;
sintering a part of the layer of ceramic powder by a laser light according to a preset pattern;
removing the other part of the layer of ceramic powder without being sintered to form a pattern layer, with portions of the upper surface without being covered with the pattern layer; and
coating an oil resistance layer on a side of the pattern layer facing away from the substrate and the portions of the upper surface of the substrate without being covered with the pattern layer.

6. The method of claim 5, wherein the major composition of the ceramic powder is aluminum phosphate and silicon dioxide.

7. The method of claim 5, wherein the major composition of the oil resistance layer is metal nanometer film.

8. The method of claim 7, wherein coating the oil resistance layer comprises:
coating a layer of metal film on the pattern layer and the portions of the upper surface of the substrate without being covered with the pattern layer;
changing the structure of the metal film into a micro nanostructure by a rapid thermal process; and
chemically modifying a surface of the micro nanostructure by an organics containing fluorine.

9. The method of claim 5, further comprising coating an anti-ultraviolet film on the lower surface.

10. The method of claim 5, further comprising cutting the substrate with the pattern layer and the oil resistance layer into a plurality of pieces by a laser light.
